(19) United States
(12) Patent Application Publication
(10) Pub. No.: US 2012/0163904 A1
(43) Pub. Date: Jun. 28, 2012

(54) Seal assembly for pin joint

(75) Inventors: Simon S. Liang, Aurora, IL (US); Roopam Khare, Aurora, IL (US)

(73) Assignee: CATERPILLAR INC., Peoria, IL (US)

(21) Appl. No.: 13/335,777

(22) Filed: Dec. 22, 2011

Related U.S. Application Data
(60) Provisional application No. 61/426,768, filed on Dec. 23, 2010.

(51) Int. Cl. F16C 11/04; F16J 15/34

(52) U.S. Cl. 403/161; 277/361

(57) ABSTRACT

A pin joint assembly for a machine includes a seal assembly having first and second seal rings and first and second gaskets or toric load rings. The first and second seal rings each have a loading surface and a sealing face. The first and second seal rings abut one another such that the sealing faces are in contacting relationship with each other. The first load ring engages a load ring engagement surface of a collar and the loading surface of the first seal ring. The second load ring engages a load ring engagement surface of a bushing and the loading surface of the second seal ring. At least one of the load ring engagement surface of the collar and the loading surface of the first seal ring is adapted to retain the first load ring in proximal relationship to the sealing face of the first seal ring.

### CROSS-REFERENCE TO RELATED APPLICATION

This patent application claims the benefit of priority to U.S. Provisional Patent Application No. 61/426,768, filed Dec. 23, 2010, and entitled “Seal Assembly for Pin Joint,” which is incorporated in its entirety herein by this reference.

### TECHNICAL FIELD

This patent disclosure relates generally to a pin joint for machinery and equipment and, more particularly, to a seal assembly for a pin joint.

### BACKGROUND

Pin joints are employed on many types of residential and industrial machinery and equipment to provide, for instance, pivot points between adjoining components. Most pin joints include various assemblies and structures intended to help prevent premature breakage or wear, such as, components that define chambers for holding lubricant, for example. However, pin joints can be used to support extreme radial and axial loads which cause high mechanical and thermal stress and strain of pin joint assemblies. Such stress and strain not only can cause component breakage and wear, but also can cause leakage or release of lubricant, which in turn can lead to further component breakage and wear as well as environmental pollution. This occurrence has become so frequent that some machinery and equipment are designed to regularly pump fresh lubricant into pin joints in order to replace continually-leaking lubricant. As demands on pin joint assemblies increase in succeeding generations of machinery and equipment, more robust pin joint assembly designs are highly desirable.

Commonly-owned U.S. Pat. No. 7,309,186 to Oertley (“the '186 patent”), is entitled, “Pin Cartridge for a Pin Joint.” Specifically, the '186 patent describes a pin cartridge assembly that includes a pin, a bushing, a collar at each end of the pin, and a sleeve bearing between each end of the bushing and the pin. Two-element seals known to those of ordinary skill in the art as “can and lip” seals help retain lubricant in the pin cartridge.

Commonly-owned U.S. Patent Application Publication No. US 2010/0209180 (the '180 publication) is entitled, “Pin Joint Assembly.” The '180 publication is directed to a pin joint assembly including a pin defining a longitudinal axis and having an end portion; a bushing coaxial with the pin about the longitudinal axis and having an end portion; a collar engaging the end portion of the pin and having an inner portion in proximal relation to the end portion of the bushing and an outer portion in distal relation to the end portion of the bushing; and a seal having first and second seal rings and first and second load rings, the first and second seal rings abutting one another, the first load ring engaging and separating the collar and the first seal ring, and the second load ring engaging and separating the bushing and the second seal ring.

It will be appreciated that this background description has been created by the inventor to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a pin joint assembly including a pin defining a longitudinal axis and having an end portion; a bushing coaxial with the pin about the longitudinal axis and having an end portion with a load ring engagement surface; a collar engaging the end portion of the pin and having an inner portion in proximal relation to the end portion of the bushing, the inner portion including a load ring engagement surface, and an outer portion in distal relation to the end portion of the bushing; and a seal assembly having first and second seal rings and first and second load rings or tonic rings. The first and second seal rings each have a loading surface and a sealing face. The first and second seal rings abut one another such that the sealing faces are in contacting relationship with each other. The first load ring engages the load ring engagement surface of the collar and the loading surface of the first seal ring. The second load ring engages the load ring engagement surface of the bushing and the loading surface of the second seal ring. At least one of the load ring engagement surface of the collar and the loading surface of the first seal ring is adapted to retain the first load ring in proximal relationship to the sealing face of the first seal ring.

In one aspect, the first load ring has a circular cross-sectional shape having a radius “R.” The first load ring is retained such that its cross-sectional center is disposed a distance away from the sealing face that is based upon the radius “R” of the load ring. In one embodiment, the distance is within a range between and including about 1.5× the radius “R” and about 1.8× the radius “R.”

In other embodiments, a seal assembly is adapted for use in sealing a joint having a first member pivotable about a rotational axis relative to a second member thereof. The first member and the second member each include a load ring engagement surface. The seal assembly includes first and second annular seal rings and first and second annular load rings.

The first and second seal rings each have an axially-extending loading surface and a radially-extending sealing face. The first and second seal rings abut one another such that the sealing faces of the first and second seal rings are in contacting relationship with each other. The first load ring has a generally circular cross-sectional shape when in an unloaded condition with a predetermined radius.

The first load ring engages the load ring engagement surface of the first member and the loading surface of the first seal ring. The second load ring engages the load ring engagement surface of the second member and the loading surface of the second seal ring. At least one of the load ring engagement surface of the first member and the loading surface of the first seal ring includes an annular projection that extends radially therefrom and is adapted to limit the axial movement of the first load ring relative to the sealing face of the first seal ring such that the cross-sectional center of the first load ring is disposed an axial distance from the sealing face of the first seal ring within a range of travel up to about twice the cross-sectional radius of the first load ring when in an unloaded condition.

In other embodiments, a pin joint assembly includes a pin defining a longitudinal axis, a first member, and a second member both coaxial with the pin about the longitudinal axis. The first member is pivotable about the longitudinal axis with respect to the second member. The first member includes an inner end and a load ring engagement surface. The second member includes an outer end and a load ring engagement surface. The inner end of the first member is in proximal relationship to the outer end of the second member. The load ring engagement surfaces of the first member and the second member define, at least in part, an axially-extending seal cavity interposed between the first member and the second member.

The pin joint assembly further includes a seal assembly disposed in the seal cavity between the first member and second member. The seal assembly includes first and second annular seal rings and first and second annular load rings.

The first and second seal rings each have a loading surface and a sealing face. The first and second seal rings abut one another such that the sealing faces of the first and second seal rings are in contacting relationship with each other.

The first load ring engages the load ring engagement surface of the first member and the loading surface of the first seal ring. The second load ring engages the load ring engagement surface of the second member and the loading surface of the second seal ring. At least one of the load ring engagement surface of the first member and the loading surface of the first seal ring includes an annular projection that extends radially from said surface and is adapted to limit the axial movement of the first load ring relative to the sealing face of the first seal ring such that the cross-sectional center of the first load ring is disposed an axial distance from the sealing face of the first seal ring within a range of travel up to about twice the radius of the first load ring when in an unloaded condition.

In other embodiments, a machine includes a frame having a first member, a component having a second member, and a pin joint having a seal assembly. The component is pivotally attached to the frame via the pin joint.

The seal assembly includes first and second annular seal rings and first and second annular load rings. The first and second seal rings each have an axially-extending loading surface and a radially-extending sealing face. The first and second seal rings abut one another such that the sealing faces of the first and second seal rings are in contacting relationship with each other.

The first load ring has a generally circular cross-sectional shape when in an unloaded condition with a predetermined radius. The first load ring engages the load ring engagement surface of the first member and the loading surface of the first seal ring. The second load ring engages the load ring engagement surface of the second member and the loading surface of the second seal ring. At least one of the load ring engagement surface of the first member and the loading surface of the first seal ring includes an annular projection that extends radially therefrom and is adapted to limit the axial movement of the first load ring relative to the sealing face of the first seal ring such that the cross-sectional center of the first load ring is disposed an axial distance from the sealing face of the first seal ring within a range of travel up to about twice the cross-sectional radius of the first load ring when in an unloaded condition.

Further and alternative aspects and features of the disclosed principles will be appreciated from the following detailed description and the accompanying drawings. As will be appreciated, the seal assemblies for a pin joint, the pin joints, and machines disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a fragmentary, side elevational view of an embodiment of a machine having a pin joint with a seal assembly in accordance with principles of the present disclosure connecting a lift arm to a non-engine end.

FIG. 2 is a perspective view of the pin joint of FIG. 1.

FIG. 3 is a cross-sectional view of the pin joint taken along line III-III in FIG. 1.

FIG. 4 is an enlarged, fragmentary view, in section, of the seal assembly of FIG. 1 corresponding to the location encompassed by circle IV in FIG. 3.

FIG. 4A is an inset detail view depicting a cross-sectional view of an annular load ring suitable for use in a seal assembly constructed in accordance with principles of the present disclosure and illustrating the load ring in an unloaded and uncompressed state.

FIG. 5 is an enlarged, fragmentary view of another embodiment of an end portion of a collar having a load ring engagement surface suitable for use in a seal assembly constructed in accordance with principles of the present disclosure.

FIG. 5A is an inset detail view depicting a cross-sectional view of an annular load ring suitable for use in a seal assembly constructed in accordance with principles of the present disclosure and illustrating the load ring in an installed, compressed state wherein the load ring is disposed between a load ring engagement surface of a first member and an inclined seal ramp portion of a seal ring.

FIG. 6 is an enlarged, fragmentary view, in section and similar to the view of FIG. 4, of another embodiment of a seal assembly in accordance with principles of the present disclosure.

FIG. 7 is an axial end view of a seal ring of the seal assembly of FIG. 4.

FIG. 8 is an enlarged, cross-sectional view, shown in perspective, taken along line VIII-VIII in FIG. 7.

FIG. 9 is an enlarged, fragmentary view of the seal ring of FIG. 7 corresponding to the location encompassed by circle IX in FIG. 7.

FIG. 10 is a chart illustrating the seal force generated as a function of the distance a load ring of the seal assembly of FIG. 4 is from a seal face.

FIG. 11 is a view of the seal assembly of FIG. 4 similar to the view of FIG. 4, but illustrating the effect of large deformations occurring under pin loading.

FIG. 12 is an axial end view of a seal ring of the seal assembly of FIG. 4 illustrating the effect of large deformations occurring under pin loading as in FIG. 11.

FIG. 13 is an enlarged, fragmentary view, in section and similar to the view of FIG. 4, of a conventional seal assembly.

FIG. 14 is an axial end view of a seal ring of the seal assembly of FIG. 13.

FIG. 15 is an enlarged, cross-sectional view, shown in perspective, taken along line XV-XV in FIG. 14.

FIG. 16 is an enlarged, fragmentary view of the seal ring of FIG. 14 corresponding to the location encompassed by circle XVI in FIG. 14.

FIG. 17 is a chart illustrating the face load generated as a function of the seal gap between a collar and a bushing for both the seal assembly of FIG. 4 and the prior art seal assembly of FIG. 13.

FIG. 18 is an axial end view of the seal ring of the prior art seal assembly of FIG. 13 illustrating the effect of large deformations occurring under pin loading as in FIGS. 11 and 12.

### DETAILED DESCRIPTION

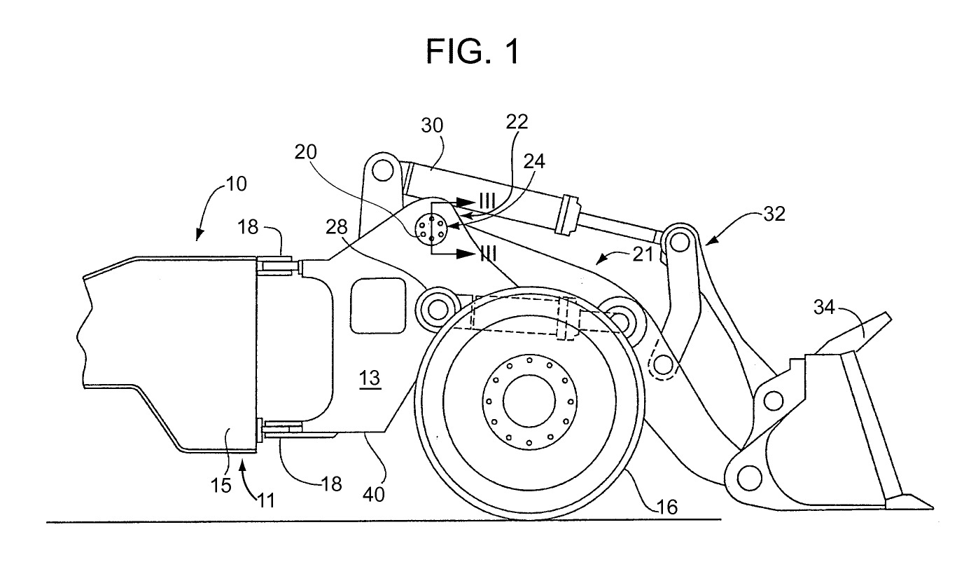

Referring now to the drawings and in particular to FIG. 1, a machine 10 in the form of a wheel loader is shown. It should be understood, however, that many other types of machines such as backhoes, excavators, material handlers and the like that include pivotal linkage arrangements can utilize a pin joint and seal assembly constructed in accordance with principles of the present disclosure. Examples of other such machines include machines used for compaction, mining, construction, farming, transportation, etc.

The machine 10 has a frame 11 with a front or non-engine end portion 13 and a rear or engine end portion 15. A plurality of ground-engaging members 16 (e.g., wheels, tracks, etc.) one of which is shown, can be connected to the front portion 13 and the rear portion 15 of the structural frame through axles, drive shafts or other components (not shown). A hitch arrangement pivotally connects the front portion 13 to the rear portion 15 by way of a pair of hinge joints 18. The engine end portion 15 of the frame 11 can support, for example, a power source and cooling system components (not shown), the power source being operatively connected through a drive train (not shown) to drive at least one ground engaging device 16 (such as, a plurality of wheels, as shown) for movement of the machine 10.

The front portion 13 of the frame 11 has a first member 20 engaged therewith, such as by frame members or flanges in spaced relationship to each other, for example. A component 21, in the form of a lift arm assembly or boom, for example, has a second member 22 engaged therewith and is pivotally connected to the front portion 13 of the frame 11 by a pin joint assembly 24.

A lift cylinder 28 is pivotally connected between the front portion 13 of the frame and the lift arm assembly or boom 21. A tilt cylinder 30 is connected between the front portion 13 and a linkage arrangement 32. The boom 21, the lift cylinder 28, the tilt cylinder 30 and the linkage arrangement 32 can raise, lower and angle an attached implement 34, such as a bucket, during loading and unloading operations, for example.

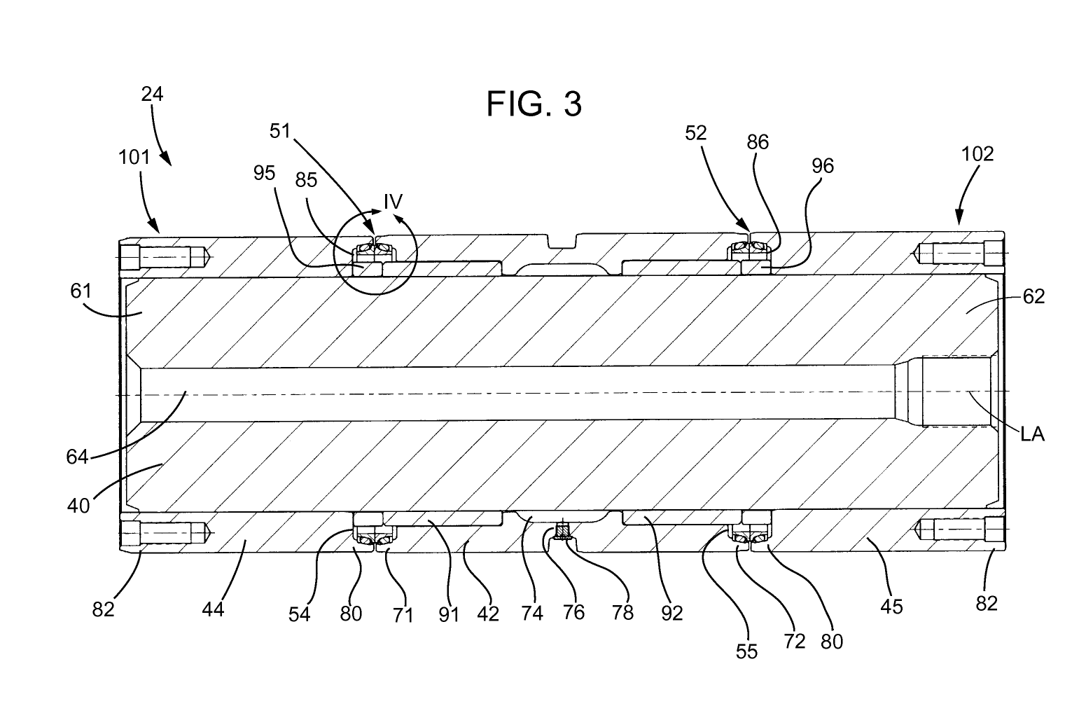

Turning now to FIG. 3, the pin joint assembly 24 includes a pin 40 extending through a bushing 42 and first and second collars 44, 45. The pin 40 defines a longitudinal axis “LA.” The bushing 42 is intermediately disposed along the longitudinal axis “LA” between the first and second collars 44, 45. First and second metal-to-metal face seal assemblies 51, 52 are disposed in axially-extending first and second seal cavities 54, 55 between the first collar 44 and the bushing 42 and the bushing 42 and the second collar 45, respectively. The bushing 42 is rotatable about the longitudinal axis “LA” relative to the pin 40 and the first and second collars 44, 45 with the first and second seal assemblies 51, 52 respectively providing running seals therebetween.

In some embodiments, the first member 20 can comprise the first collar 44 and the second member 22 can comprise the bushing 42 which are both coaxial with the pin 40 about the longitudinal axis “LA.” The second member 22 in the form of the bushing 42 is pivotable about the longitudinal axis “LA” with respect to the first member 20 in the form of the first collar 44 and with respect to the pin 40. It should be understood, however, that the use of the terms “first,” “second,” and the like herein is for convenient reference only and is not limiting in any way.

The pin 40 includes opposing first and second end portions 61, 62. The pin 40 includes an axial bore 64 coaxially arranged with the longitudinal axis “LA.” The axial bore 64 can be sized to accommodate a mounting element therethrough, such as a draw bolt, for example.

The bushing 42 includes opposing first and second end portions 71, 72. The bushing 42 is coaxial with the pin 40 about the longitudinal axis “LA.” The bushing 42 defines a substantially centrally disposed cavity 74 for receiving lubricant (not shown). The cavity 74 is adapted to be filled with oil for lubricating the rotating interfaces of the pin joint assembly 24. In this regard, a threaded opening 76 is plugged with a removable threaded plug 78 to allow lubricant to be added to the cavity 74.

The first and second collars 44, 45 respectively engage the first and second end portions 61, 62 of the pin 40 and are adapted to be rotatively coupled with the pin 40. The first and second collars 44, 45 are coaxial with the pin 40 about the longitudinal axis “LA.” The first and second collars 44, 45 each have an inner portion 80 and an outer portion 82. The inner portions 80 of the first and second collars 44, 45 are respectively oriented in proximal relation to the first and second end portions 71, 72 of the bushing 42. The outer portions 82 of the first and second collars 44, 45 are respectively oriented in outward distal relation to the first and second end portions 71, 72 of the bushing 42.

The first end portion 71 of the bushing 42, the inner portion 80 of the first collar 44, and the pin 40 cooperate to define the first seal cavity 54. Similarly, the second end portion 72 of the bushing 42, the inner portion 80 of the second collar 45, and the pin 40 cooperate to define a substantially annular second channel 86, also for receiving lubricant (not shown). The first end portion 71 of the bushing 42, the inner portion 80 of the first collar 44, and the pin 40 cooperate to define the first seal cavity 54. Similarly, the second end portion 72 of the bushing 42, the inner portion 80 of the second collar 45, and the pin 40 cooperate to define the second seal cavity 55.

First and second annular sleeve bearings 91, 92 can be provided which are coaxial with the pin 40 about the longitudinal axis “LA.” The first and second sleeve bearings 91, 92 engage the pin 40 and respectively engage the first and second end portions 71, 72 of the bushing 42.

First and second thrust rings 95, 96 can be provided which are coaxial with the pin 40 about the longitudinal axis “LA.” The first and second thrust rings 95, 96 respectively reside in the first and second channels 85, 86. The thrust rings 95, 96 are oriented in spaced-apart relation relative to the bushing 42.

The first thrust ring 95 engages the pin 40 between the inner portion 80 of the first collar 44 and the first sleeve bearing 91. The second thrust ring 96 engages the pin 40 between the inner portion 80 of the second collar 45 and the second sleeve bearing 92. The first and second thrust rings 95, 96 can intermittently or continuously engage the first and second sleeve bearings 91, 92, respectively, during use of the pin joint assembly 24.

The first and second seal assemblies 51, 52 are respectively disposed in the first and second seal cavities 54, 55 and are coaxial with the pin 40 about the longitudinal axis “LA.” The first and second seal assemblies 51, 52 allow the bushing 42 to rotate with respect to the first and second collars 44, 45 and maintain a sealing relationship between the first and second collars 44, 45 and the bushing 42 such that the first and second annular channels 85, 86 for receiving lubricant can substantially retain lubricant housed therein.

The first collar 44, the first thrust ring 95, the first sleeve bearing 91, and the first seal assembly 51 comprise a first subassembly 101 of the pin joint assembly 24. The second collar 45, the second thrust ring 96, the second sleeve bearing 92, and the second seal assembly 52 comprise a second subassembly 102 of the pin joint assembly 24.

The first and second seal assemblies 51, 52 are substantially identical to each other. Furthermore, the first and second subassemblies 101, 102 are substantially identical to each other. It should be understood, therefore, that the description of one seal assembly is applicable to the other seal assembly and the description of one subassembly is applicable to the other subassembly, as well.

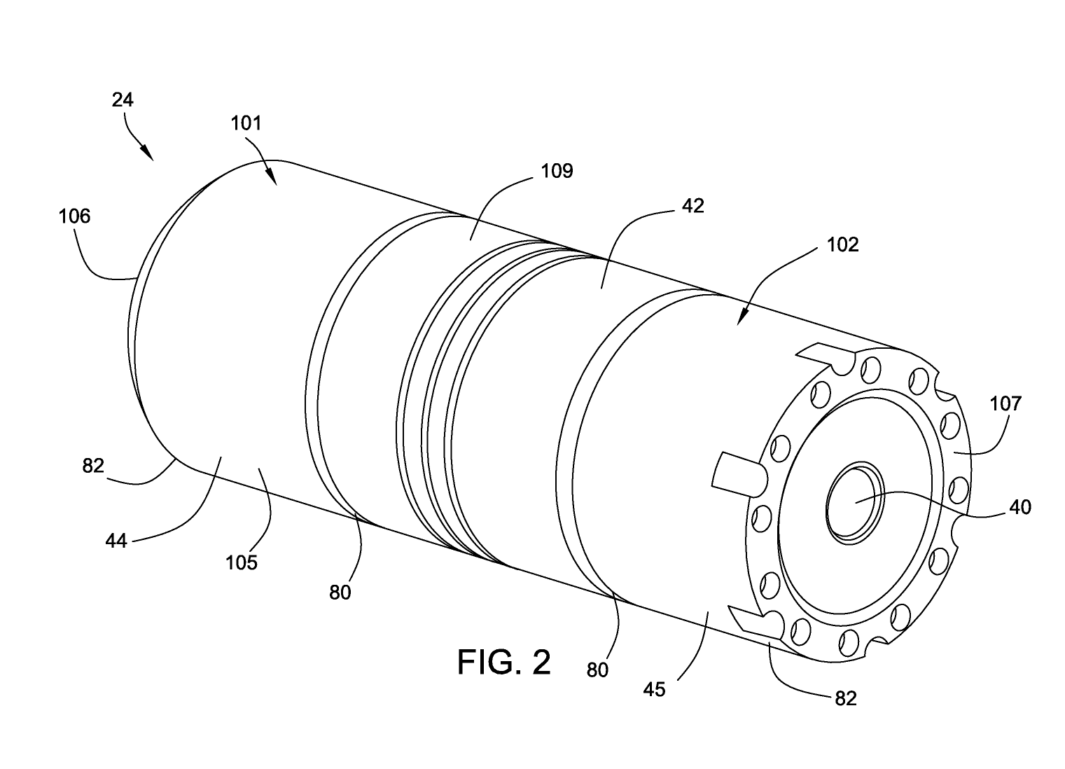

Referring to FIG. 2, the pin joint assembly 24—including the pin 40, the bushing 42, and the subassemblies 101, 102—can be provided in a unitary cartridge 105 in order to ease maintenance and/or replacement of the pin joint assembly 24. The cartridge 105 is substantially cylindrical but can be configured such that it tapers slightly radially inwardly in outer diameter from the outer portion 82 of one collar 45 to the outer portion 82 of the other collar 44. In other embodiments, the cartridge 105 can taper in the opposite direction. In yet other embodiments, the cartridge 105 can taper in outer diameter from each distal end portion 106, 107 of the cartridge 105 to a central cylindrical region 109 thereof. For example, in one embodiment, the first and second collars 44, 45 can taper inwardly in outer diameter from the inner portion 80 to the outer portion 82, and the bushing 42 can be substantially cylindrical. The tapered outer diameter of the cartridge 105 can be provided to help allow the cartridge 105 to be installed by swaging, but any alternative structures or features that enable secure installation of the cartridge 105 can be utilized in other embodiments.

In other embodiments, such as in those situations where the application and environment in which the pin joint assembly is employed so warrant, the pin joint assembly 24 can include only one of the subassemblies 101, 102, in which case only the corresponding end portion of the pin 40 and end portion of the bushing 42 may be provided with a subassembly—that is, a collar, a thrust ring, a sleeve bearing, and a seal assembly. In such instances, the opposing end portion of the pin 40, and the corresponding end portion of the bushing 42 in proximal relation thereto, not being provided with all elements of a subassembly, may be provided with no elements of a subassembly or some elements of a subassembly. For instance, by way of example and not by way of limitation, if the first end portion 61 of the pin 40 and the first end portion 71 of the bushing 42 are provided with the first subassembly 101, the second end portion 62 of the pin 40 and the second end portion 72 of the bushing 42 may be provided with only the second sleeve bearing 92 and the second seal assembly 52 and omitting the second collar 45 and the second thrust ring 96.

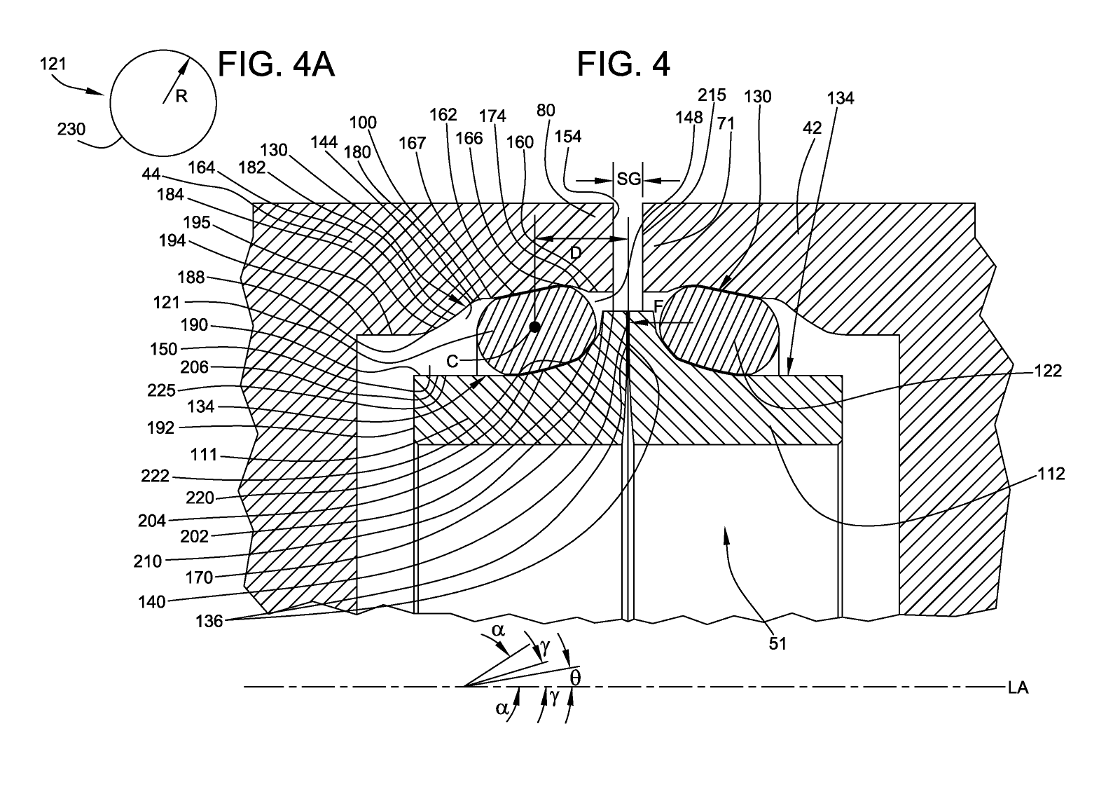

Referring to FIG. 4, the first seal assembly 51 is disposed in the seal cavity 54 between the first member 20 in the form of the first collar 44 and the second member 22 in the form of the bushing 42. The first seal assembly 51 includes first and second annular seal rings 111, 112 and first and second gaskets or annular load rings 121, 122. The first and second seal rings 111, 112 of the first seal assembly 51 are disposed in abutting relationship with each other. The first and second load rings 121, 122 are respectively mounted to the first and second seal rings 111, 112. The first and second seal rings 111, 112 can be made from any suitable metal. The first and second load rings 121, 122 are preferably made from a suitable elastomeric material.

In the first seal assembly 51, the first load ring 121 acts as a gasket and sealingly engages the first collar 44 and the first seal ring 111. The second load ring 122 acts as a gasket and sealingly engages the bushing 42 and the second seal ring 112. As will be understood, therefore, in the second seal assembly 52, the first load ring 121 sealingly engages the second collar 45 and the first seal ring 111, and the second load ring 122 sealingly engages the bushing 42 and the second seal ring 112.

The inner portion 80 of the first collar 44 is in proximal relation to the first end portion 71 of the bushing 42. The inner portion 80 of the first collar 44 and the first end portion 71 of the bushing 42 each includes a load ring engagement surface 130. The load ring engagement surfaces 130 of the first member 20 in the form of the first collar 44 and the second member 22 in the form of the bushing 42 define, at least in part, the axially-extending first seal cavity 54 interposed between the first member 20 and the second member 22. It will be understood that the second end portion 72 of the bushing 42 cooperates with the second collar 45 in a similar manner to define, at least in part, the axially-extending second seal cavity 55 interposed between the bushing 42 and the second collar 45.

The load ring engagement surfaces 130 are generally annular and are coaxial with the longitudinal axis “LA.” In the illustrated embodiment, the load ring engagement surfaces 130 maintain the cross-sectional shape shown in FIG. 4 substantially continuously around the entire circumference circumscribed around the longitudinal axis “LA.”

The first and second seal rings 111, 112 are substantially identical to each other. The first and second seal rings 111, 112 are each in the form of an annulus. The first and second seal rings 111, 112 each have an axially-extending ramped loading surface 134 and a radially-extending sealing face 136. The annular, radially-extending sealing faces 136 of the first and second seal rings 111, 112 are in opposing relationship with each. The first and second seal rings 111, 112 abut one another such that the sealing faces 136 of the first and second seal rings 111, 112 are in contacting relationship with each other.

The first and second load rings 121, 122 are substantially identical to each other. The first and second load rings 121, 122 each has a generally circular cross-sectional shape when in an unloaded condition with a predetermined radius “R” (see FIG. 4A).

The first load ring 121 engages the load ring engagement surface 130 of the first collar 44 and the loading surface 134 of the first seal ring 111. The second load ring 122 engages the load ring engagement surface 130 of the bushing 42 and the loading surface 134 of the second seal ring 112. The first and second load rings 121, 122 are positioned such that they drive the sealing faces 136 of the first and second seal rings 111, 112 together to define a band 140 of contact therebetween. The load rings 121, 122 act in the manner of a spring to apply an axial load respectively against the first and second seal rings 111, 112 in opposing directions along the longitudinal axis “LA” to bring the sealing faces 136 of the first and second seal rings 111, 112 into face-to-face sealing contact under pressure along the band 140 of contact such that a running fluid-tight seal is formed.

The first and second seal rings 111, 112 are rotationally movable with respect to each other about the longitudinal axis “LA.” In this arrangement, the first seal ring 111 can be considered a stationary seal ring as it is rotatively coupled with the first collar 44. The second seal ring 112 can be considered a rotational seal ring as it is coupled with the bushing 42 and can rotate relative to the pin 40.

The load ring engagement surfaces 130 of the first collar 44 and the bushing 42 are adapted to retain the first and second load rings 121, 122 in proximal relationship to the sealing faces 136 of the first and second seal rings 111, 112, respectively. The load ring engagement surfaces 130 of the first collar 44 and the bushing 42 are mirror images. The loading surfaces 134 of the first and second seal rings 111, 112 are substantially identical to each other. Accordingly, it should be understood that the description below of the load ring engagement surface 130 of the first collar 44 and the loading surface 134 of the first seal ring 111 is applicable respectively to the load ring engagement surface 130 of the bushing 42 and the loading surface 134 of the second seal ring 112, as well.

The load ring engagement surface 130 of the first collar 44 and the loading surface 134 of the first seal ring 111 are in confronting, spaced apart relationship such that they define an annular load ring cavity 144 within which the first load ring 121 is disposed. The load ring engagement surface 130 of the first collar 44 and the loading surface 134 of the first seal ring 111 cooperate together to define a seal end restriction 148 adjacent the sealing face 136 of the first seal ring 111 and a load end restriction 150 in distal relationship to the sealing face 136 of the first seal ring 111. The seal end restriction 148 is configured to help prevent the first load ring 121 from sliding axially off of the first seal ring 111 in a direction toward the second seal ring 112 and to help prevent the first load ring 121 from extending into a pinch point therein. The load end restriction 150 is configured to help limit the relative axial movement of the first load ring 121 in a direction away from the sealing face 136 of the first seal ring 111 to a predetermined range of travel within a placement zone in proximal relationship to the sealing face 136 of the first seal ring 111.

The load ring engagement surface 130 of the first collar 44 extends axially from an inner end face 154 thereof and faces radially inwardly. The load ring engagement surface 130 of the first collar 44 includes a peripheral retaining lip 160 adjacent the inner end face 154 of the first collar 44, a confronting inclined load ramp portion 162, and a reverse curve portion 164. The inclined load ramp portion 162 is disposed between the retaining lip 160 and the reverse curve portion 164. The inclined load ramp portion 162 includes a seal end 166 adjacent the retaining lip and a load end 167 disposed adjacent the reverse curve portion 164.

The retaining lip 160 projects radially inwardly relative to the seal end 166 of the inclined load ramp portion 162. The retaining lip 160 cooperates with an outer perimeter 170 of the sealing face 136 of the first seal ring 111 to define the seal end restriction 148. A concave transition segment 174 can be provided between the retaining lip 160 and the seal end 166 of the inclined load ramp portion 162.

The inclined load ramp portion 162 is bounded at its seal end 166 by the concave transition segment 174 and at its load end 167 by the reverse curve portion 164. The load end 167 of the inclined load ramp portion 162 is in distal relationship with respect to the sealing face 136 of the first seal ring 111. The inclined load ramp portion 162 is substantially frusto-conical and is inclined at a predetermined load ramp angle “θ” relative to the longitudinal axis “LA” such that the seal end 166 of the inclined load ramp portion 162 is disposed radially outwardly of the load end 167 thereof.

The reverse curve portion 164 includes a concave segment 180, an inflection segment 182, and a convex segment 184. The concave segment 180 is adjacent the load end 167 of the inclined load ramp portion 162, and the convex segment 184 is disposed in distal relationship to the sealing face 136 of the first seal ring 111. The inflection segment 182 is disposed between the concave segment 180 and the convex segment 184. The inflection segment 182 extends along an inflection angle “α” relative to the longitudinal axis “LA” that is greater than the load ramp angle “θ.” In the illustrated embodiment, the inflection angle “α” is about four times greater than the ramp angle “θ.” In other embodiments, the inflection angle “α” can have a different relationship with respect to the ramp angle “θ.”

The convex segment 184 of the reverse curve portion 164 defines an annular projection 188 that extends radially inwardly with respect to the load end 167 of the inclined load ramp 162. The projection 188 is adapted to limit the relative axial movement of the first load ring 121 in a direction along the longitudinal axis “LA” away from the sealing face 136. The load end restriction 150 can be defined at least in part by the annular projection 188. The projection 188 cooperates with an outer perimeter 190 of a load end 192 of the first seal ring 111, which is in opposing relationship to the sealing face 136 thereof, to define the load end restriction 150.

The convex segment 184 is adjacent a counterbore portion 194 of the first collar 44 that includes a substantially cylindrical side wall 195 that is coaxial with the longitudinal axis “LA.” The sidewall 195 of the counterbore portion 194 is disposed radially inwardly with respect to the outer perimeter 170 of the sealing face 136 of the first seal ring 111.

The loading surface 134 of the first seal ring 111 faces radially outwardly and includes a seating portion 202, an inclined seal ramp portion 204, and a cylindrical portion 206. The inclined seal ramp portion 204 is disposed between the seating portion 202 and the cylindrical portion 206.

The seating portion 202 projects radially outwardly relative to the inclined seal ramp portion 204 and terminates at the outer perimeter 170 of the sealing face 136. The seating portion 202 radially overlaps with the band of contact 140 between the sealing faces 136. The seating portion 202 is generally concave and is adapted to surroundingly engage the first load ring 121. The seating portion 202 is configured such that it terminates radially at a corner 210 that is adapted to help reduce load ring deformation in instances where a seal gap distance “SG” along the longitudinal axis “LA” between the inner end face 154 of the first collar 44 and an end face 215 of the first end portion 71 of the bushing 42 is very small.

The inclined seal ramp portion 204 of the first seal ring 111 is bounded at a seal end 220 by the seating portion 202 and at a load end 222 by the cylindrical portion 206. The load end 222 of the inclined seal ramp portion is in distal relationship with respect to the sealing face 136 of the first seal ring 111. The inclined seal ramp portion 204 is substantially frusto-conical and is inclined at a seal ramp angle “γ” relative to the longitudinal axis “LA” such that the seal end 220 of the seal ramp portion 204 is disposed radially outwardly of the load end 222 thereof. The seal ramp angle “γ” of the seal ramp portion 204 of the first seal ring 111 can be substantially equal to the load ramp angle “θ” of the load ramp portion 162 of the first collar 44. In other embodiments, the seal ramp angle “γ” of the seal ramp portion 204 of the first seal ring 111 can be greater than the load ramp angle “θ” of the load ramp portion 162 of the first collar 44. In other embodiments, the seal ramp angle “γ” of the seal ramp portion 204 of the first seal ring 111 can have a different relationship with respect to the load ramp angle “θ” of the load ramp portion 162 of the first collar 44. The seal ramp 204 is configured such that it extends along the longitudinal axis “LA” less than the load ramp 162 such that the load end 192 of the seal ramp 204 is closer to the sealing face 136 along the longitudinal axis “LA” than the load end 167 of the load ramp 162 of the first collar 44 to facilitate the placement of the first load ring 121 in a desired placement zone.

The cylindrical portion 206 of the first seal ring 111 includes an external sidewall 225 that is substantially cylindrical and coaxial with the longitudinal axis “LA.” The external sidewall 225 defines the outer perimeter 190 of the load end 192 of the first seal ring 111 to define the load end restriction 150 in cooperation with the projection 188 of the first collar 44.

In one aspect, the desired placement zone is based upon a geometric property of the first load ring 121. For example, the first load ring 121 is substantially in the form of a torus with a substantially circular cross-sectional shape 230 having a radius “R” when not deformed by a load (see FIG. 4A). In the illustrated embodiment, the first load ring 121 is retained such that its cross-sectional center “C” is disposed a distance “D” away from the sealing face 136 of the first seal ring 111 that is within a predetermined range of travel based upon the cross-sectional size of the first load ring 121. In some embodiments, the distance “D” is within a range or travel up to about twice the radius “R.” In other embodiments, the distance “D” is within a range or travel from about 1.5× the radius “R” to about 1.8× the radius “R.”

In some embodiments, at least one of the load ring engagement surface 130 of the first collar 44 and the loading surface 134 of the first seal ring 111 includes the radially-extending annular projection 188 adapted to limit the axial movement of the first load ring 121 relative to the sealing face 136 of the first seal ring 111 such that the cross-sectional center “C” of the first load ring 121 is disposed an axial distance “D” from the sealing face 136 of the first seal ring 111 within a range of travel up to about twice the cross-sectional radius “R” of the first load ring 111 when in an unloaded condition. In other embodiments, the annular projection 188 is adapted to limit the axial movement of the first load ring 121 relative to the sealing face 136 of the first seal ring 111 such that the cross-sectional center “C” of the first load ring 121 is disposed an axial distance “D” from the sealing face 136 of the first seal ring 111 within a range of travel up to about one hundred eighty percent of the cross-sectional radius “R” of the first load ring 121 when in an unloaded condition, and in other embodiments within a range of travel from about one hundred fifty percent to about one hundred eighty percent of the cross-sectional radius “R” of the first load ring 121 when in an unloaded condition.

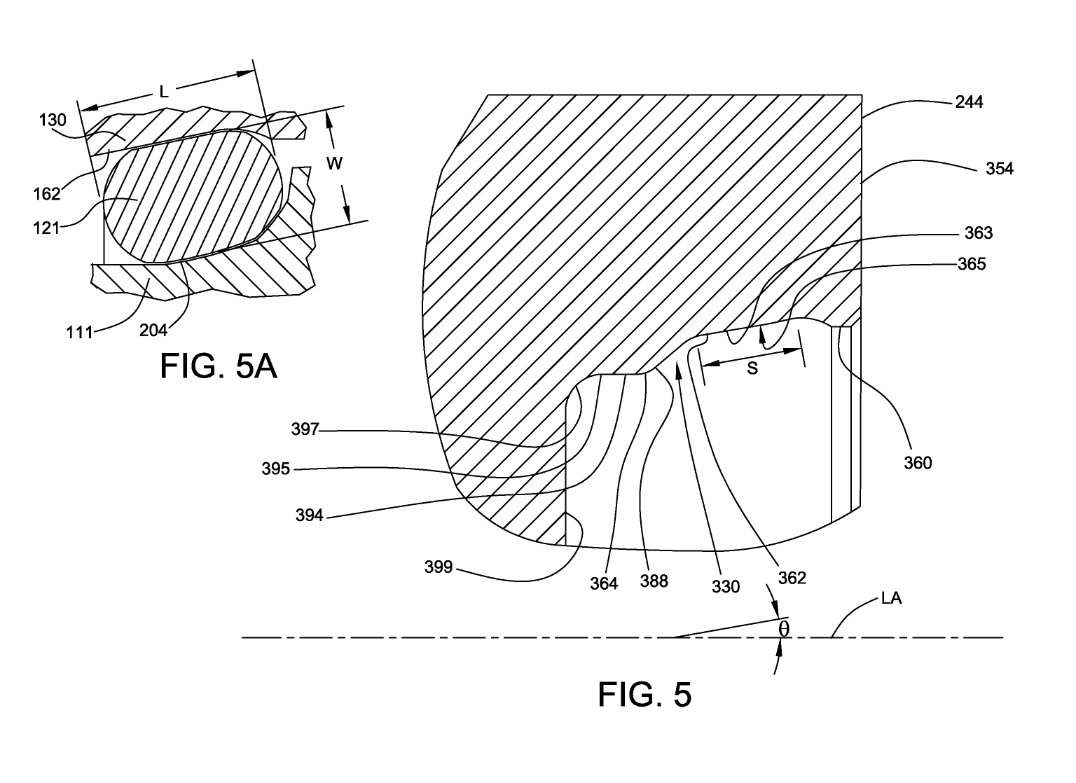

Referring to FIG. 5, another embodiment of a load ring engagement surface 330 suitable for use with a seal assembly constructed in accordance with principles of the present disclosure is shown. The load ring engagement surface 330 is disposed on a first collar 244.

The load ring engagement surface 330 of the first collar 244 extends axially from an inner end face 354 thereof and faces radially inwardly. The load ring engagement surface 330 of the first collar 244 includes a peripheral retaining lip 360 adjacent the inner end face 354 of the first collar 244, a confronting inclined load ramp portion 362, and a reverse curve portion 364 defining an annular projection 388. The inclined load ramp portion 362 is disposed between the retaining lip 360 and the reverse curve portion 364.

A counterbore portion 394 includes a substantially cylindrical side wall 395 that is coaxial with the longitudinal axis “LA.” A curved transition 397 is provided between the sidewall 395 of the counterbore portion 394 and a base 399 thereof. The load ring engagement surface 330 of FIG. 5 is similar to the load ring engagement surface 130 of FIG. 4 in other respects.

In some embodiments, the position of the annular projection 388 can be based upon the desired length “S” of a substantially flat frusto-conical region 363 of the inclined load ramp portion 362 which defines a load ring placement zone where the length “S” is measured along an axis substantially parallel to the cross-sectional surface 365 of the frusto-conical region. The annular projection 388 can be disposed adjacent to the substantially flat frusto-conical region 363.

The length “S” of the substantially flat frusto-conical region 363 can be based upon the length “L” that the first load ring 121 will take on when it is in a loaded condition between the load ring engagement surface 330 and the first seal ring 111. For example, in some embodiments, the length “S” of the substantially flat frusto-conical region 363 can be determined according to the following formula:

S≦L+1.2(SG/cos γ), (1)

where “L” is the length of the load ring 121 when disposed between the first seal ring 111 and the first member 20 in the form of the first collar 44, for example; “SG” is the axial distance separating the first member 20 in the form of the first collar 44 and the second member 22 in the form of the bushing 42 (see FIG. 4); and “γ” is the acute seal ramp angle formed between the inclined seal ramp portion 204 of the first seal ring 111 (associated with the load ring engagement surface 330) and the rotational axis “LA.”

In other embodiments, a similar formula which replaces the seal ramp angle “γ” of the seal ramp portion 204 of the first seal ring 111 with the load ramp angle “θ” of the load ramp portion 162 of the first collar 44 can be used to determine the length “S” of the substantially flat frusto-conical region 363. In embodiments, the seal ramp angle “γ” of the seal ramp portion 204 of the first seal ring 111 and the load ramp angle “θ” of the load ramp portion 162 of the first collar 44 can be an acute angle up to about thirty degrees, up to about twenty-five degrees in other embodiments, up to about twenty degrees in other embodiments, and between about 8 and about twenty degrees in still other embodiments.

In instances where the seal ramp angle “γ” of the seal ramp portion 204 of the first seal ring 111 is substantially equal to the load ramp angle “θ” of the load ramp portion 362, and assuming that the load ring comprises an incompressible elastomeric material, the length “L” of the load ring 121 when disposed between the first seal ring 111 and the first member 20 in the form of the first collar 44, for example (see FIG. 5A), can be determined according to the following formula:

$$L = W + ( π {R}^{2} - \frac{π {W}^{2}}{4} ) / W \qquad ( 2 )$$

where “W” is the distance between the inclined seal ramp 204 of the loading surface of the first seal ring 111 and the confronting inclined load ramp portion 162 of the load ring engagement surface 130 (see FIG. 5A), and “R” is the cross-sectional radius “R” of the first load ring 121 when in an unloaded condition (see FIG. 4A).

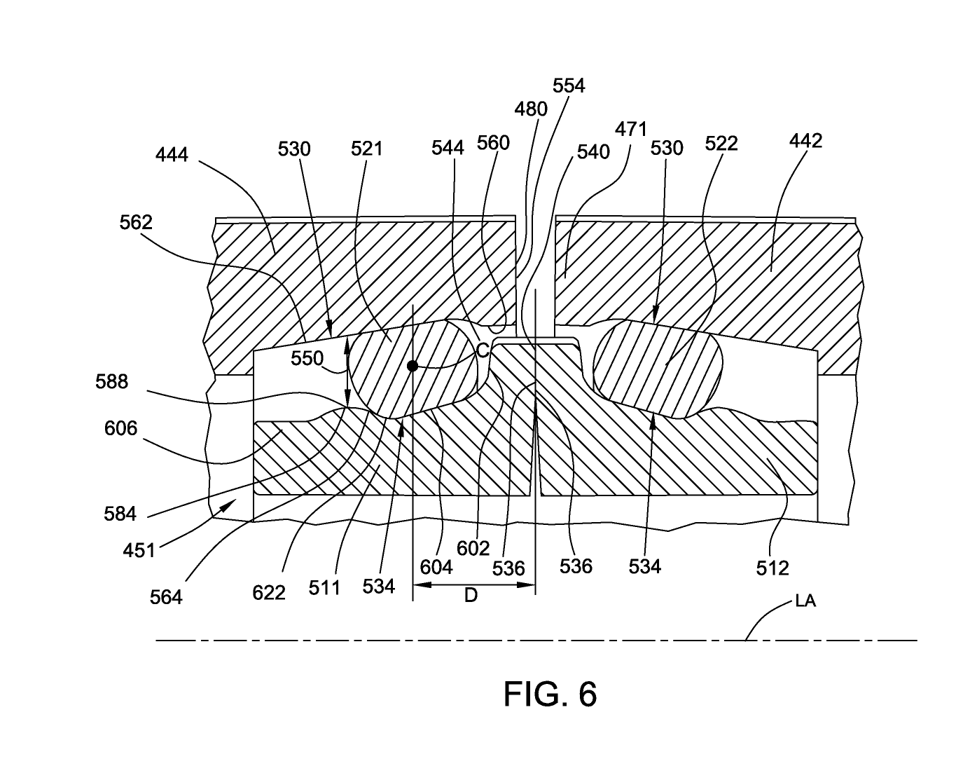

Referring to FIG. 6, another embodiment of a seal assembly 451 is shown. The seal assembly 451 includes first and second seal rings 511, 512 and first and second gaskets or toric load rings 521, 522. The first load ring 521 sealingly engages the first collar 444 and the first seal ring 511. The second load ring 522 sealingly engages the bushing 442 and the second seal ring 512.

The inner portion 480 of the first collar 444 is in proximal relation to the first end portion 471 of the bushing 442. The inner portion 480 of the first collar 444 and the first end portion 471 of the bushing 442 each includes a load ring engagement surface 530. The first and second seal rings 511, 512 each have a loading surface 534 and a sealing face 536.

The first load ring 521 engages the load ring engagement surface 530 of the first collar 444 and the loading surface 534 of the first seal ring 511. The second load ring 522 engages the load ring engagement surface 530 of the bushing 442 and the loading surface 534 of the second seal ring 512. The first and second load rings 521, 522 are positioned such that they drive the sealing faces 536 of the first and second seal rings 511, 512 together to define a band 540 of contact therebetween.

The load ring engagement surface 530 of the first collar 444 and the loading surface 534 of the first seal ring 511 are in confronting, spaced apart relationship such that they define an annular load ring cavity 544 within which the first load ring 521 is disposed. The load ring cavity 544 is configured to help limit the relative axial movement of the first load ring 521 along the longitudinal axis “LA” in a direction away from the sealing face 536 of the first seal ring 511 to a predetermined range of travel within a placement zone.

The load ring engagement surface 530 of the first collar 444 extends from an inner end face 554 thereof and faces radially inwardly. The load ring engagement surface 530 of the first collar 444 includes a peripheral retaining lip 560 adjacent the inner end face 554 of the first collar 444 and an inclined load ramp portion 562.

The loading surface 534 of the first seal ring 511 faces radially outwardly and includes a seating portion 602, an inclined seal ramp portion 604, a reverse curve portion 564 and a cylindrical portion 606. The inclined seal ramp portion 604 is disposed between the seating portion 602 and the reverse curve portion 564, which in turn is disposed between the inclined seal ramp portion 604 and the cylindrical portion 606. The cylindrical portion 606 is in distal relationship with the sealing face 536 of the first seal ring 511.

The reverse curve portion 564 includes a convex segment 584 that defines an annular projection 588 that extends radially outwardly with respect to a load end 622 of the inclined seal ramp portion 604. The projection 588 cooperates with the load ramp portion 562 to define a load end restriction 550. The projection 588 is adapted to limit the relative axial movement of the first load ring 521 in a direction along the longitudinal axis “LA” away from the sealing face 536 such that a cross-sectional center “C” of the first load ring 521 is disposed a distance “D” away from the sealing face 536 of the first seal ring 511 that is within a predetermined placement zone such that the first load ring 521 is in proximal relationship to the sealing face 536. The seal assembly 451 is similar to the first seal assembly 51 of FIG. 4 in other respects.

### Example 1

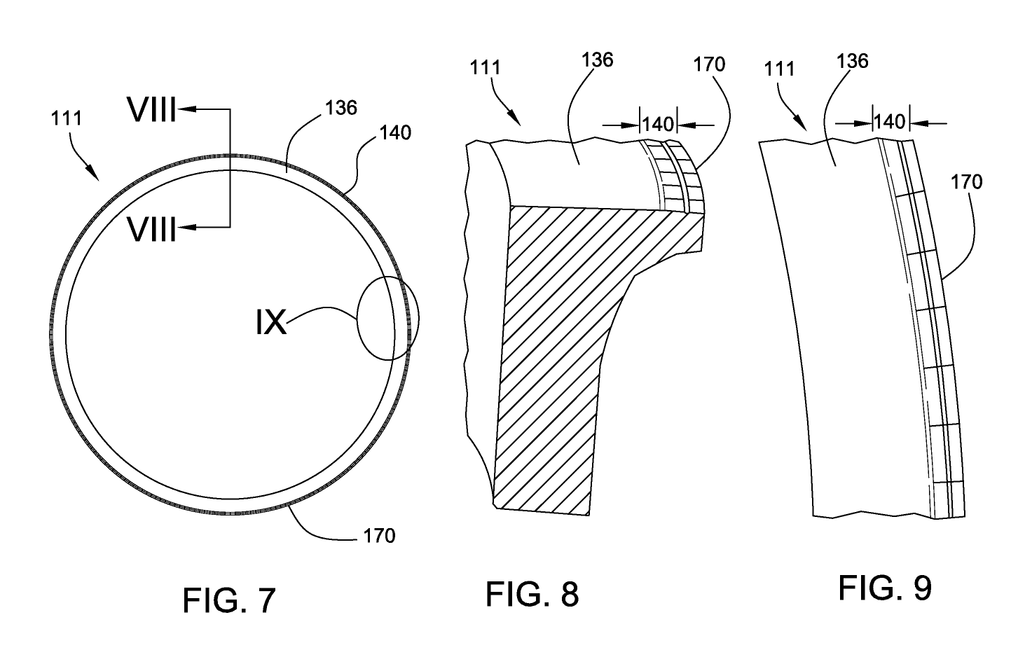

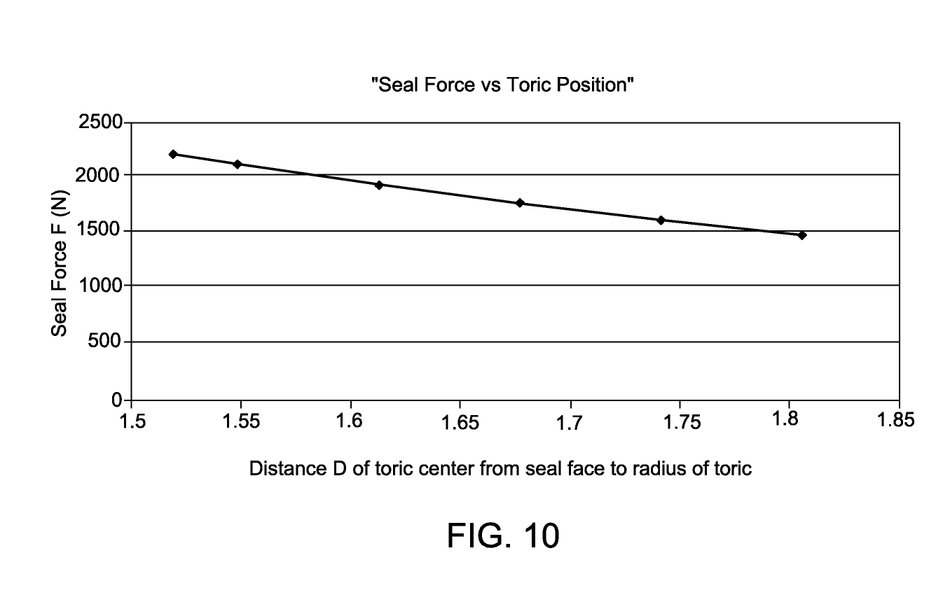

Referring to FIGS. 7-9, the first seal ring 111 of the first seal assembly 51 of FIG. 4 is shown. Using finite element analysis simulation techniques, the contact band 140 between the sealing faces 136 was determined to be adjacent the outer perimeter 170 of the sealing face 136 when the first load ring 121 was disposed in the placement zone having a distance “D” from the sealing face 136 and the cross-sectional center “C” of the first load ring 121 wherein the distance “D” is within a range of travel between and including about 1.5× the radius “R” of the first load ring 121 and about 1.8× the radius “R” of the first load ring 121. FIG. 10 is a chart showing how the seal force “F” acting along the longitudinal axis “LA” (see FIG. 4) varies as a function of the distance “D” the cross-sectional center “C” of the first load ring 121 is from the sealing face 136 of the first seal ring 111.

### Example 2

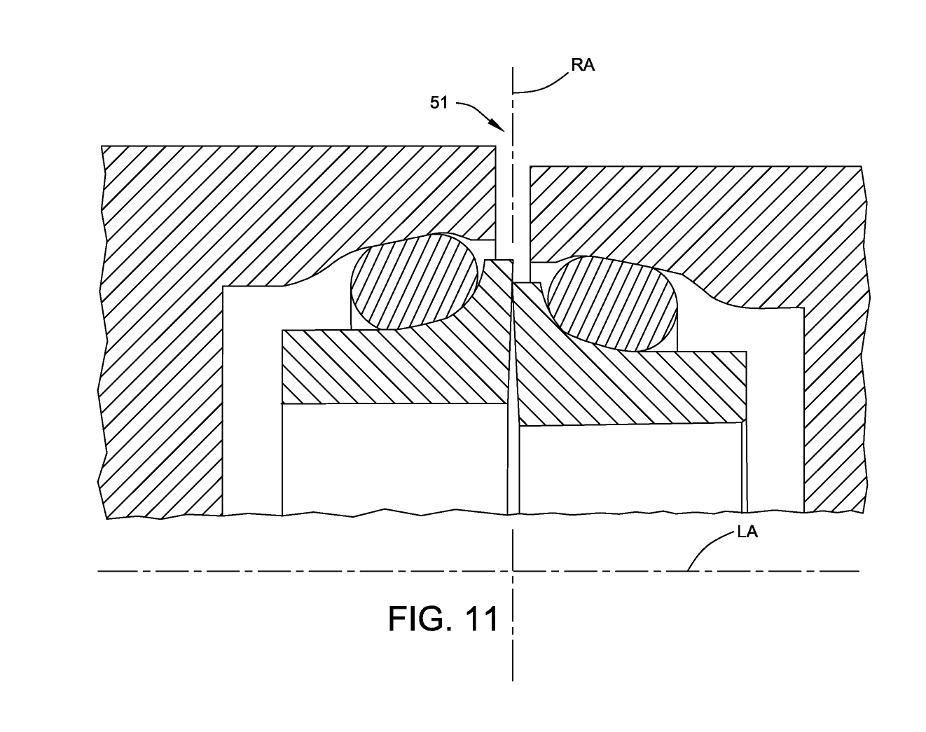

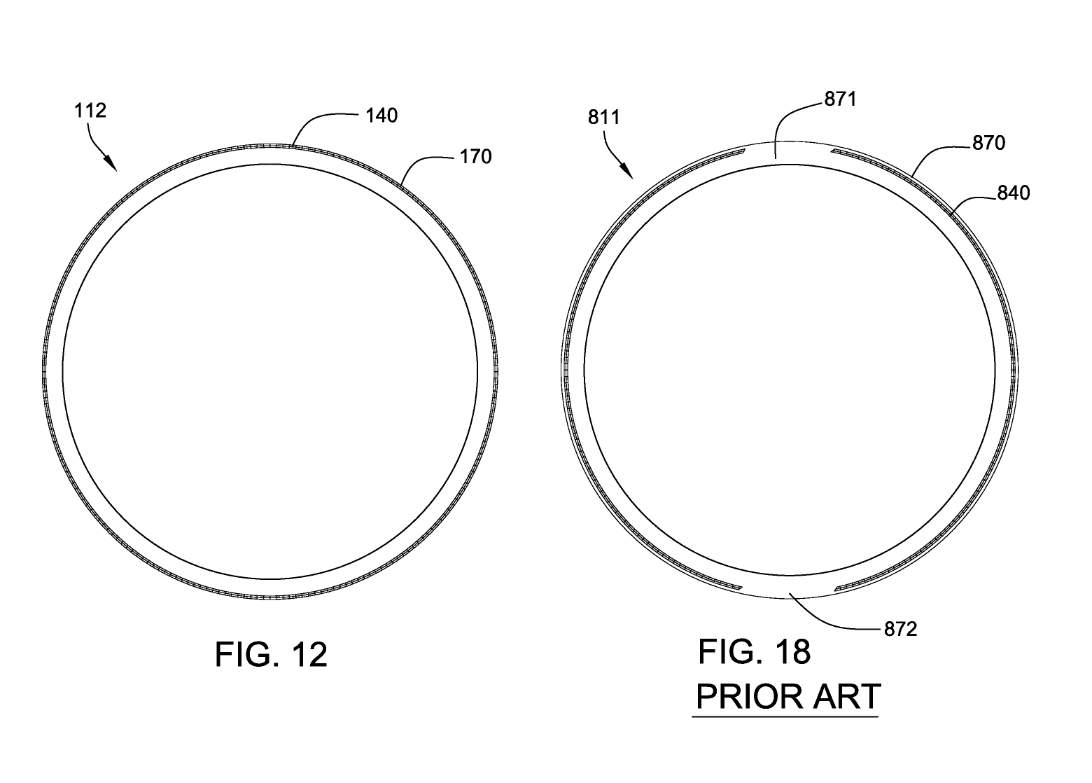

Referring to FIGS. 11 and 12, using finite element analysis simulation techniques, the first seal assembly 51 described above was subjected to radial deformations along a radial axis “RA” substantially perpendicular to the longitudinal axis “LA.” As shown in FIG. 12, the band of contact 140 remained continuous around the outer perimeter 170 of the sealing face 136 of at least one of the seal rings 112.

### INDUSTRIAL APPLICABILITY

The industrial applicability of the embodiments of a pin joint provided with a seal assembly described herein will be readily appreciated from the foregoing discussion. The described principles are applicable to machines and equipment including a pivotal linkage arrangement between a pair of members such that one member is rotatably movable with respect to the other member. A pin joint having at least one seal assembly constructed in accordance with the present principles can be used to provide the pivotal linkage. Examples of such machines include compaction machines, including a wheel loader, for example. The seal assemblies disclosed herein can advantageously be offered on new equipment, or can be used to retrofit existing equipment operating in the field.

During use, the pin 40 of the pin joint assembly 24 can be held stationary by the first and second collars 44, 45. The bushing 42 can rotate about the longitudinal axis “LA” while engaging the pin 40 and the first and second sleeve bearings 91, 92. The first and second sleeve bearings 91, 92, in turn, rotate about the longitudinal axis “LA” while engaging the bushing 42 and the pin 40. The interposition of the first and second sleeve bearings 91, 92 between the bushing 42 and the pin 40 provides two pairs of hardware interfaces, namely a pair of bushing-to-sleeve bearing interfaces and a pair of sleeve bearing-to-pin interfaces. As a result, if any particular hardware interface that enables rotation of the bushing 42 should lose lubrication, thereby resulting in full or partial seizing of the interface, the remaining, unseized hardware interfaces can help enable the bushing 42 to continue rotating. In this way, the various hardware interfaces provide redundancy to help enable the rotation of the bushing 42 demanded during routine use of the pin joint assembly 24.

The pin joint assembly 24 endures radial loads during use, as well as axial loads along or in substantially parallel relation to the longitudinal axis “LA.” While the sleeve bearings 91, 92 help the pin joint assembly 24 bear radial loads, the first and second thrust rings 95, 96 help the pin joint assembly 24 bear axial loads. Specifically, during use, the thrust rings 95, 96 slide along the pin 40 and/or compress and decompress in reaction to axial loads, thereby dampening axial loads and, by extension, helping to reduce wear of the pin joint assembly 24 caused by axial loads. The thrust rings 95, 96 reside wholly within the channels 85, 86, respectively, and as a result are better enabled to move as necessary to bring about such dampening. Further, the sleeve bearings 91, 92 extend beyond the bushing 42 into the channels 85, 86, respectively, thereby spacing the thrust rings 95, 96 apart from the bushing 42 in order to help prevent the rotation of the bushing 42 from interfering with the movement and/or compression and decompression of the thrust rings 95, 96 during use of the pin joint assembly 24.

The first and second seal assemblies 51, 52 help prevent lubricant (not shown) from leaking out of the channels 85, 86, respectively. Specifically, the first and second seal rings 111, 112 of each of the seal assemblies 51, 52 rotate against one another in sealing engagement. The load rings 121, 122 of each of the seal assemblies 51, 52 act in the manner of a spring to apply an axial load respectively against the first and second seal rings 111, 112 in opposing directions along the longitudinal axis “LA” to bring the sealing faces 136 of the first and second seal rings 111, 112 of each of the seal assemblies 51, 52 into face-to-face sealing contact under pressure along a band 140 of contact such that a running fluid-tight seal is formed. The structure of each of the seal assemblies 51, 52 maintains the first and second load rings 121, 122 in proximal relationship to the first and second seal rings 111, 112, respectively, to promote the opposing axial forces exerted by the first and second seal rings 111, 112 against each other. Accordingly, lubricant (not shown) can be restrained from escaping the first and second channels 85, 86 and the first and second subassemblies 101, 102 under difficult loading conditions.

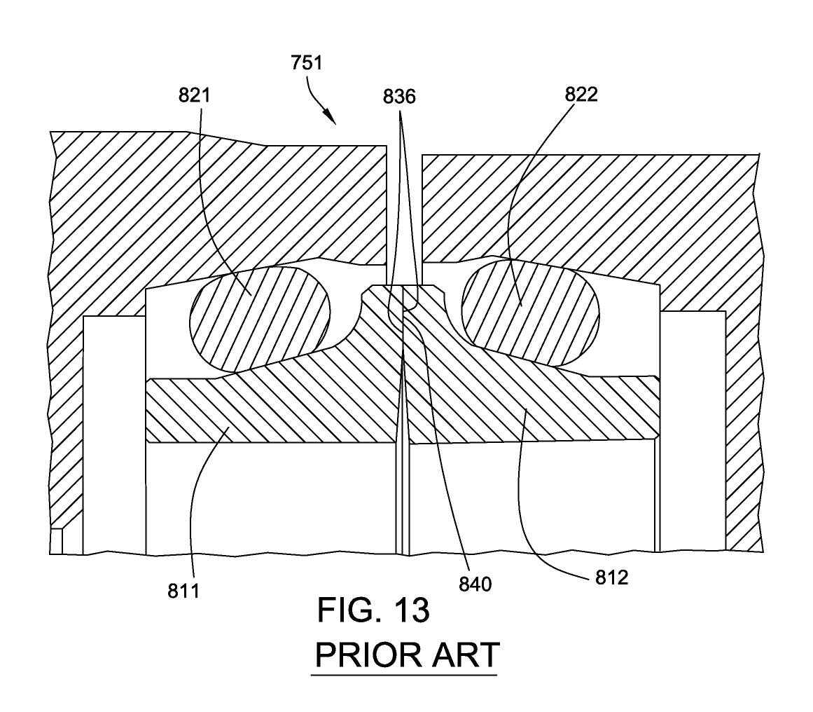

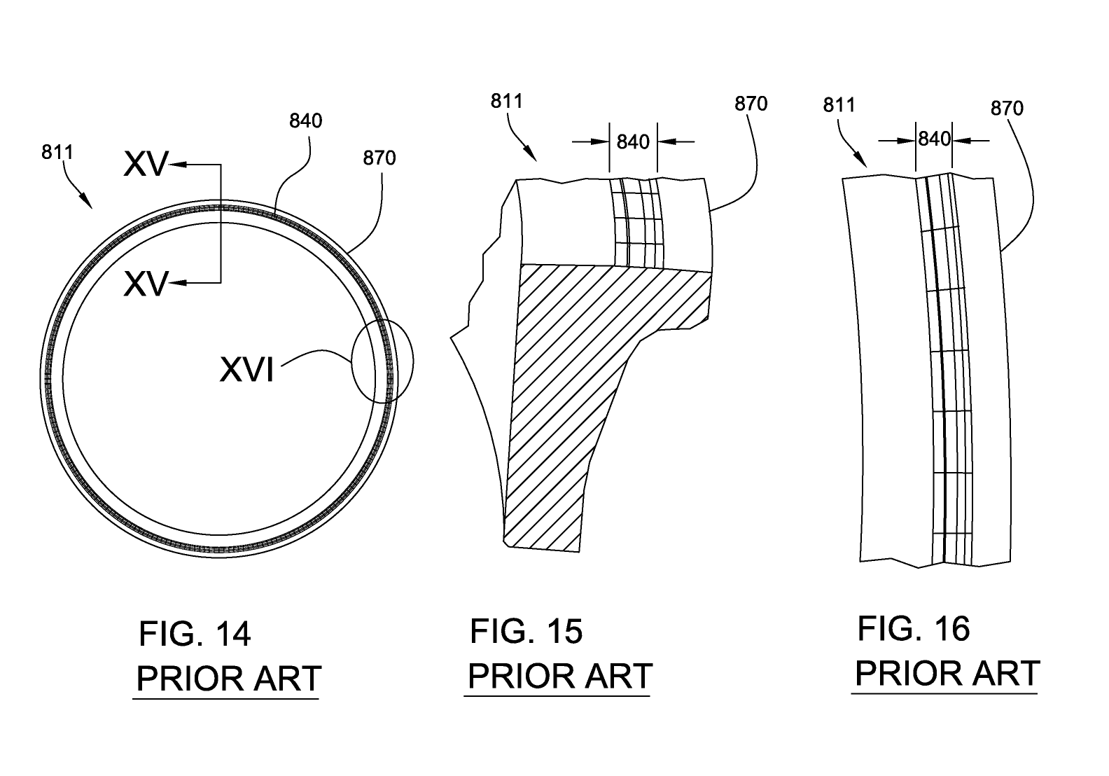

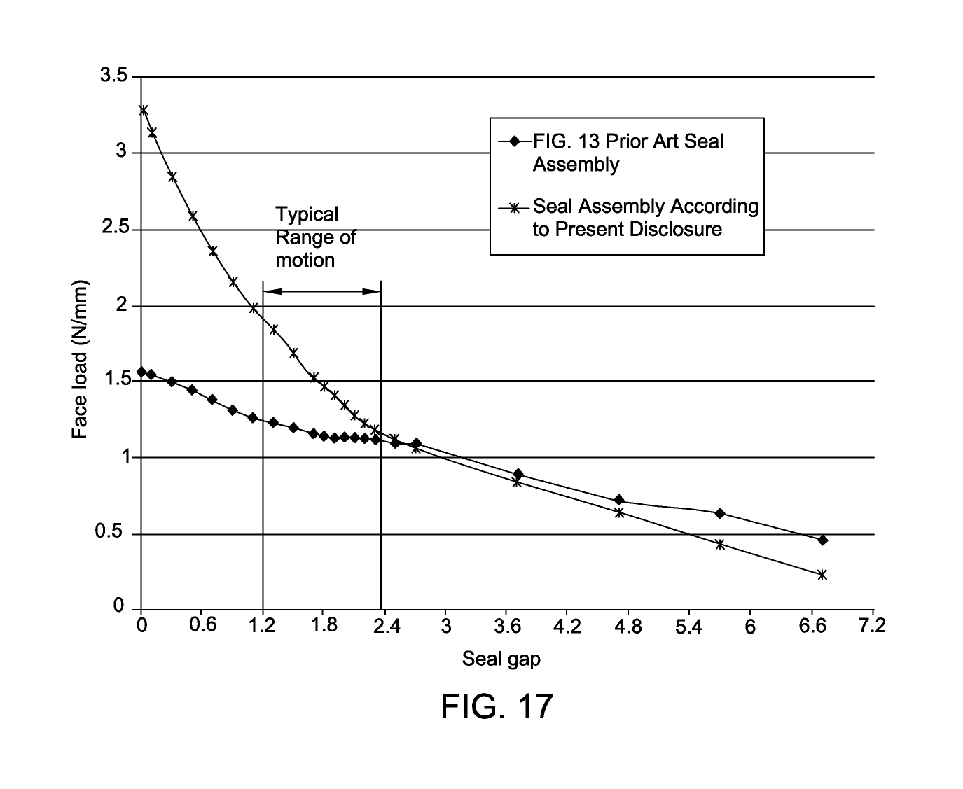

Computer modeling simulations have demonstrated that a seal assembly constructed in accordance with the present disclosure can provide improved axial sealing forces over prior seal assembly configurations. Referring to FIG. 13, a conventional seal assembly 751 with a conventional seal ring 811 is shown. Referring to FIGS. 14-16, using finite element analysis (FEA) simulation techniques similar to those in Example 1, the band 840 of contact between the sealing faces 836 of the seal rings 811, 812 of the conventional seal assembly 751 of FIG. 13 was determined to be offset from the outer perimeter 870 of the seal ring 811.

Referring to FIG. 17, FEA simulations were conducted to determine how the sealing face load “F” varied as a function of the seal gap “SG” (see FIG. 4). The FEA simulations showed that a seal assembly 51 constructed in accordance with principles of the present disclosure (such as that shown in FIG. 4) exhibited a higher face load than that of the conventional seal assembly 751 of FIG. 13.

In addition, referring to FIG. 18, using FEA simulation techniques similar to those in Example 2, the conventional seal assembly 751 of FIG. 13 was subjected to radial deformations along a radial axis “RA” substantially perpendicular to the longitudinal axis “LA.” As shown in FIG. 18, the band of contact 840 of the conventional seal ring 811 exhibits a plurality of discontinuities 871, 872. However, as shown in FIG. 12, the band of contact 140 of the seal assembly 51 of FIG. 4 constructed in accordance with principles of the present disclosure remained continuous around the outer perimeter 170 of the sealing face 136 of at least one of the rings 112. These unexpected results demonstrate the increased sealing forces and sealing integrity obtained by a seal assembly for a pin joint constructed in accordance with principles of the present disclosure over a conventional seal assembly.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A seal assembly adapted for use in sealing a joint having a first member pivotable about a rotational axis relative to a second member thereof, the first member and the second member each including a load ring engagement surface, the seal assembly comprising:
first and second annular seal rings, the first and second seal rings each having a loading surface extending axially and a sealing face extending radially, the first and second seal rings abutting one another such that the sealing faces of the first and second seal rings are in contacting relationship with each other; and
first and second annular load rings, the first load ring having a generally circular cross-sectional shape when in an unloaded condition, the first load ring engaging the load ring engagement surface of the first member and the loading surface of the first seal ring, the second load ring engaging the load ring engagement surface of the second member and the loading surface of the second seal ring;
wherein at least one of the load ring engagement surface of the first member and the loading surface of the first seal ring includes an annular projection that extends radially therefrom and is adapted to limit axial movement of the first load ring relative to the sealing face of the first seal ring such that a cross-sectional center of the first load ring is disposed an axial distance from the sealing face of the first seal ring within a range of travel up to about twice a cross-sectional radius of the first load ring when in the unloaded condition.

2. The seal assembly of claim 1, wherein the annular projection is adapted to limit axial movement of the first load ring relative to the sealing face of the first seal ring such that the axial distance the cross-sectional center of the first load ring is disposed from the sealing face of the first seal ring is within a range of travel up to about one hundred eighty percent of the cross-sectional radius of the first load ring when in the unloaded condition.

3. The seal assembly of claim 1, wherein the annular projection is adapted to limit axial movement of the first load ring relative to the sealing face of the first seal ring such that the axial distance the cross-sectional center of the first load ring is disposed from the sealing face of the first seal ring is within a range of travel from about one hundred fifty percent to about one hundred eighty percent of the cross-sectional radius of the first load ring when in the unloaded condition.

4. The seal assembly of claim 1, wherein the loading surface of the first seal ring includes a seating portion, an inclined seal ramp portion, and a cylindrical portion, the inclined seal ramp portion being disposed between the seating portion and the cylindrical portion, the seating portion projecting radially outwardly relative to the inclined seal ramp portion and terminating at an outer perimeter of the sealing face, and the seating portion being generally concave and adapted to surroundingly engage the first load ring.

5. The seal assembly of claim 4, wherein the loading surface of the first seal ring includes a reverse curve portion having a convex segment, the convex segment defining the annular projection, the inclined seal ramp portion being disposed between the seating portion and the reverse curve portion.

6. The seal assembly of claim 1, wherein the loading surface of the first seal ring includes a reverse curve portion having a convex segment, the convex segment defining the annular projection.

7. The seal assembly of claim 1, wherein the loading surface of the first seal ring includes an inclined seal ramp portion, and the annular projection is disposed adjacent to a substantially flat frusto-conical region defining a load ring placement zone having a length S, measured along an axis substantially parallel to a cross-sectional surface of the frusto-conical region, that is equal to or less than
L+1.2(SG/cos γ),
where L is the length of the first load ring when disposed between the first seal ring and the first member, SG is an axial distance separating the first member and the second member, and γ is an acute angle formed between the inclined seal ramp portion of the first seal ring and the rotational axis.

8. The seal assembly of claim 7, wherein the length L of the first load ring when disposed between the first seal ring and the first member is equal to about
$$W + ( π {R}^{2} - \frac{π {W}^{2}}{4} ) / W ,$$
where W is a distance between the inclined seal ramp of the loading surface of the first seal ring and a confronting inclined load ramp portion of the load ring engagement surface, and R is the cross-sectional radius of the first load ring when in the unloaded condition.

9. A pin joint assembly comprising:
a pin defining a longitudinal axis;
a first member and a second member both coaxial with the pin about the longitudinal axis, the first member being pivotable about the longitudinal axis with respect to the second member, the first member including an inner end and a load ring engagement surface, the second member including an outer end and a load ring engagement surface, the inner end of the first member being in proximal relationship to the outer end of the second member, the load ring engagement surfaces of the first member and the second member defining, at least in part, a seal cavity extending axially and interposed between the first member and the second member; and
a seal assembly disposed in the seal cavity between the first member and the second member, the seal assembly comprising:
first and second annular seal rings, the first and second seal rings each having a loading surface and a sealing face, the first and second seal rings abutting one another such that the sealing faces of the first and second seal rings are in contacting relationship with each other, and
first and second annular load rings, the first load ring engaging the load ring engagement surface of the first member and the loading surface of the first seal ring, the second load ring engaging the load ring engagement surface of the second member and the loading surface of the second seal ring,
wherein at least one of the load ring engagement surface of the first member and the loading surface of the first seal ring includes an annular projection that extends radially therefrom and is adapted to limit axial movement of the first load ring relative to the sealing face of the first seal ring such that a cross-sectional center of the first load ring is disposed an axial distance from the sealing face of the first seal ring within a range of travel up to about twice a cross-sectional radius of the first load ring when in an unloaded condition.

10. The pin joint assembly of claim 9, wherein at least one of the load ring engagement surface of the second member and the loading surface of the second seal ring includes an annular projection that extends radially therefrom and is adapted to limit axial movement of the second load ring relative to the sealing face of the second seal ring such that the cross-sectional center of the second load ring is disposed an axial distance from the sealing face of the second seal ring within a range of travel up to about twice a radius of the second load ring when in an unloaded condition.

11. The pin joint assembly of claim 9, wherein the first member comprises a first collar, and the second member comprises a bushing, the bushing having a second outer end and a second load ring engagement surface, the pin joint assembly further comprising:
a second collar coaxial with the pin such that the bushing is disposed between the first collar and the second collar, the second collar including an inner end and a load ring engagement surface, the second load ring engagement surface of the bushing and the load ring engagement surface of the second collar defining, at least in part, a second seal cavity extending axially and interposed between the bushing and the second collar;
a second seal assembly disposed in the second seal cavity;
wherein the first and second collars respectively engage first and second end portions of the pin such that the first collar and the second collar are rotatively coupled with the pin;
wherein the bushing is rotatable about the longitudinal axis relative to the pin and the first collar and the second collar;
wherein the first seal assembly and the second seal assembly respectively providing running seals between the bushing and the first collar and the bushing and the second collar.

12. The pin joint assembly of claim 11, wherein the pin, the bushing, the first and second collars, and the first and second seal assemblies are provided in a unitary cartridge.

13. The pin joint assembly of claim 9, wherein the load ring engagement surface of the second member and the loading surface of the first seal ring cooperate together to define a seal end restriction adjacent the sealing face of the first load ring and a load end restriction in distal relationship to the sealing face of the first seal ring, the load end restriction being defined at least in part by the annular projection.

14. The pin joint assembly of claim 9, wherein the load ring engagement surface of the second member includes a retaining lip adjacent a periphery of the inner end of the second member, a confronting inclined load ramp portion, and a reverse curve portion, the inclined load ramp portion disposed between the retaining lip and the reverse curve portion, the reverse curve portion defining the annular projection.

15. The pin joint assembly of claim 9, wherein the annular projection is adapted to limit axial movement of the first load ring relative to the sealing face of the first seal ring such that the axial distance the cross-sectional center of the first load ring is disposed from the sealing face of the first seal ring is within a range of travel up to about one hundred eighty percent of the cross-sectional radius of the first load ring when in the unloaded condition.

16. The pin joint assembly of claim 9, wherein the annular projection is adapted to limit axial movement of the first load ring relative to the sealing face of the first seal ring such that the axial distance the cross-sectional center of the first load ring is disposed from the sealing face of the first seal ring is within a range of travel from about one hundred fifty percent to about one hundred eighty percent of the cross-sectional radius of the first load ring when in the unloaded condition.

17. The pin joint assembly of claim 9, wherein the loading surface of the first seal ring includes a reverse curve portion having a convex segment, the convex segment defining the annular projection.

18. The pin joint assembly of claim 9, wherein the loading surface of the first seal ring includes an inclined seal ramp portion, and the annular projection is disposed adjacent to a substantially flat frusto-conical region defining a load ring placement zone having a length S, measured along an axis substantially parallel to a cross-sectional surface of the frusto-conical region, that is equal to or less than
L+1.2(SG/cos γ),
where L is the length of the first load ring when disposed between the first seal ring and the first member, SG is an axial distance separating the first member and the second member, and γ is an acute angle formed between the inclined seal ramp portion of the first seal ring and the longitudinal axis.

19. The pin joint assembly of claim 18, wherein the length L of the first load ring when disposed between the first seal ring and the first member is equal to about
$$W + ( π {R}^{2} - \frac{π {W}^{2}}{4} ) / W ,$$
where W is a distance between the inclined seal ramp of the loading surface of the first seal ring and a confronting inclined load ramp portion of the load ring engagement surface, and R is the cross-sectional radius of the first load ring when in the unloaded condition.

20. A machine comprising:
a frame having a first member;
a component having a second member; and
a pin joint having a seal assembly, the component pivotally attached to the frame via the pin joint, the seal assembly comprising:
first and second annular seal rings, the first and second seal rings each having a loading surface extending axially and a sealing face extending radially, the first and second seal rings abutting one another such that the sealing faces of the first and second seal rings are in contacting relationship with each other, and
first and second annular load rings, the first load ring having a generally circular cross-sectional shape when in an unloaded condition, the first load ring engaging the load ring engagement surface of the first member and the loading surface of the first seal ring, the second load ring engaging the load ring engagement surface of the second member and the loading surface of the second seal ring,
wherein at least one of the load ring engagement surface of the first member and the loading surface of the first seal ring includes an annular projection that extends radially therefrom and is adapted to limit axial movement of the first load ring relative to the sealing face of the first seal ring such that a cross-sectional center of the first load ring is disposed an axial distance from the sealing face of the first seal ring within a range of travel up to about twice a cross-sectional radius of the first load ring when in the unloaded condition.
